(19) United States
(12) Patent Application Publication
(10) Pub. No.: US 2026/0056890 A1
(43) Pub. Date: Feb. 26, 2026

(54) HARDWARE STRUCTURES AND TECHNIQUES FOR REPLAYING PREFETCH VIRTUAL ADDRESSES

(71) Applicant: Ampere Computing LLC, Santa Clara, CA (US)

(72) Inventors: Abanti BASAK, San Jose, CA (US); Mahesh MADHAV, Portland, OR (US); Eric SCHWARTZ, Portland, OR (US); David TURLEY, Portland, OR (US)

(21) Appl. No.: 18/812,908

(22) Filed: Aug. 22, 2024

(51) Int. Cl. G06F 12/1027; G06F 9/30; G06F 13/16

(52) U.S. Cl. CPC G06F 12/1027; G06F 9/30047; G06F 13/1673

(57) ABSTRACT

Disclosed are hardware structures and techniques for replaying virtual addresses. In an aspect, a prefetcher of a processing core may send one or more prefetch virtual address candidates to a prefetch outstanding buffer. The prefetcher may determine that the one or more replay prefetch virtual addresses corresponding to the one or more prefetch virtual address candidates are ready for replay. The prefetcher may send the one or more replay prefetch virtual addresses corresponding to the one or more prefetch virtual address candidates to a buffer based on the one or more replay prefetch virtual addresses being ready for replay.

### BACKGROUND OF THE DISCLOSURE

### 1. Field of the Disclosure Aspects of the disclosure relate generally to processes associated with prefetching.

### 2. Description of the Related Art

Various hardware and software prefetching techniques may be used for speeding up fetch operations by beginning a fetch operation whose result is expected to be needed soon. Software prefetching requires programmer or compiler intervention, whereas hardware prefetching requires special hardware mechanisms. Usually, the fetch operation occurs before the corresponding data is known to be needed, so there is a risk of wasting time and resources by prefetching data that will not be used. For example, prefetching may be used by a processing core to boost execution performance by fetching instructions or data from their original storage in slower memory locations to a faster local cache memory location before the instructions or data is needed. The processing core may have relatively fast and local cache memory in which the prefetched instructions or data is held until it is to be used for processing operations.

The memory source for the prefetch operation is usually main or system-level memory but may also be a higher-level cache memory. Accessing lower-level cache memories is typically faster than accessing main or system-level memory as well as higher level cache memory. Thus, accurate prefetching of instructions or data into lower-level cache(s) from higher-level memories and then accessing it from lower-level caches when the instructions or data are needed may improve system performance.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a prefetcher includes a buffer; and a prefetch outstanding buffer operatively coupled to the buffer, wherein: the buffer is configured to send one or more prefetch virtual address candidates to the prefetch outstanding buffer, and the prefetch outstanding buffer is configured to send one or more replay prefetch virtual addresses corresponding to the one or more prefetch virtual address candidates to the buffer based on the one or more replay prefetch virtual addresses being ready for replay.

In an aspect, a processing unit includes one or more processing cores, at least one processing core of the one or more processing cores configured to: send one or more prefetch virtual address candidates to a prefetch outstanding buffer; determine that one or more replay prefetch virtual addresses corresponding to the one or more prefetch virtual address candidates are ready for replay; and send the one or more replay prefetch virtual addresses corresponding to the one or more prefetch virtual address candidates to a buffer based on the one or more replay prefetch virtual addresses being ready for replay.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example of a processing unit, according to aspects of the disclosure.

FIG. 2 illustrates an example of a domain-specific prefetcher hardware structure for prefetching virtual addresses, according to aspects of the disclosure.

FIG. 3 illustrates an example of a replay hardware structure for replaying prefetch virtual addresses, according to aspects of the disclosure.

FIG. 4 is a flowchart of an example process for replaying prefetch virtual addresses on a processing unit, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects of the subject technology relate to hardware structures and techniques for replaying prefetch virtual addresses. In some examples, a prefetch outstanding buffer (POB) may be included in a prefetcher of a processing core. The POB may receive virtual address candidates associated with prefetch operation misses that would otherwise be dropped by the prefetcher. The POB may operate to replay at least some virtual addresses corresponding to the virtual address candidates associated with the prefetch operation misses.

In some examples, a prefetcher that includes the POB may correspond to a domain-specific prefetcher for optimizing level 1 (L1) Data-cache prefetch operations. That is, for example, the virtual address candidates may correspond to prefetch virtual address misses with respect to the data translation lookaside buffer (dTLB) of the domain-specific prefetcher. Other implementations of POBs are described and contemplated as would be understood given the benefit of the disclosure.

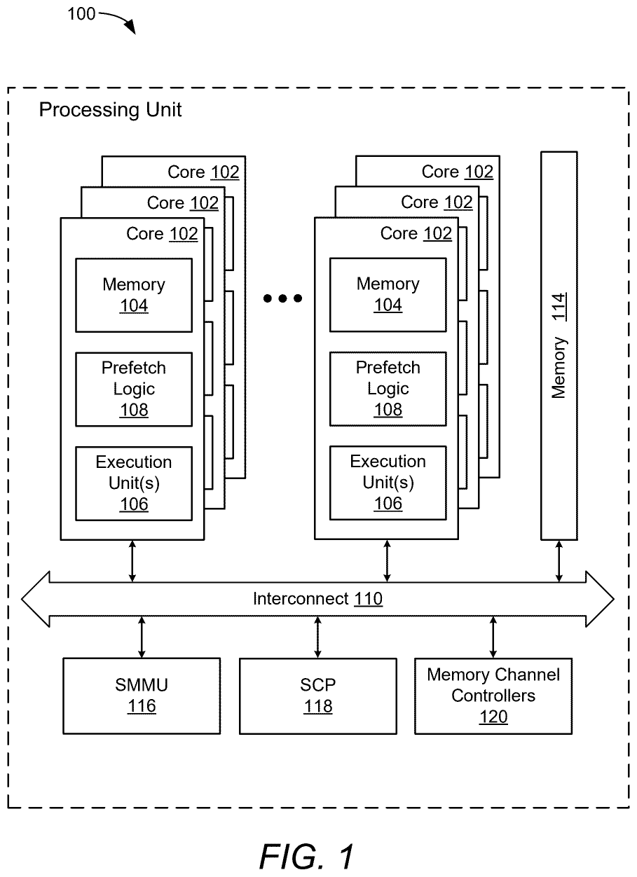

FIG. 1 illustrates a first example of a processing unit 100, according to aspects of the disclosure. In some examples, the hardware structures and techniques for replaying virtual addresses described herein may be implemented using processing unit 100. Processing unit 100 is configured as a central processing unit (CPU) but may also be used with or configured as other processing units, such as but not limited to a graphics processing (GPU) or tensor processing unit (TPU). Processing unit 100 may include a set of processing cores 102 (or simply “cores” 102). Each core 102 may include memory 104, one or more execution units 106, and prefetch logic 108. Each core 102 may be coupled to interconnect 110, which may be a system on chip (SoC) coherent interconnect. In some examples, memory 104 may be configured as cache on the core 102 (e.g., 16 kB or 64 kB L1 Instruction-cache, 64 kB L1 Data-cache, and 1 MB or 2MB level 2 (L2) Cache, in some aspects).

The one or more execution units 106 may perform various operations and calculations associated with instructions and micro-operations of the core 102. The one or more execution units 106 may be configured as various units in the core 102 in accordance with various implementations. For example, the one or more execution units 106 may include arithmetic logic units (ALUs) that perform arithmetic and logic operations for the core 102. The one or more execution units 106 may include floating point units (FPUs) that perform floating point calculations. The one or more execution units 106 may include integer execution units (IXUs) for performing integer operations. The one or more execution units 106 may also include single instruction, multiple data (SIMD) execution units for performing various instructions. In one or more aspects, an execution unit 106 may perform a combination of these and other operations. Each of the one or more execution units 106 may include a bus or interconnect, for example, to connect hardware elements of the execution units 106 to memory 104 to perform read and write functions while executing micro-operations. Alternatively, or in addition thereto, one or more execution units 106 including ALUs, FPUs, IXUs, and/or SIMD execution units may be configured for all or a subset of the cores 102.

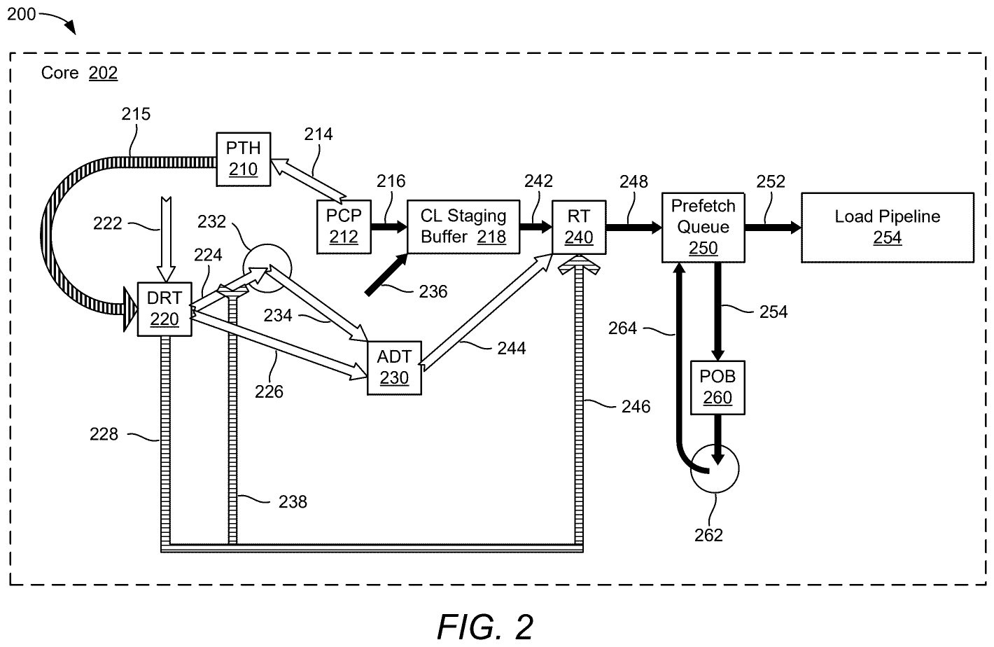

The prefetch logic 108 may include various hardware structures within the core 102. In some examples, the prefetch logic 108 may be configured to prefetch data and/or instructions associated with operations of the core 102 in accordance with various implementations. That is, for example, the prefetch logic 108 may perform fetch operations from various memory locations before the corresponding data and/or instructions are known to be needed by the execution units 106 and places the data and/or instructions into a particular cache of the memory 104 in the core 102. Various aspects and implementations of the prefetch logic 108 are described herein, for example, with respect to FIG. 2-4.

Processing unit 100 may also include memory 114, which may be coupled to interconnect 110. In some examples, memory 114 may include system-level cache (e.g., 32 MB or 64 MB, in some aspects) that may be used for various purposes by the processing unit 100. Processing unit 100 may also include a system memory management unit (SMMU) 116, The SMMU 116 may provide translation services, for example, to non-processor master units. That is, for example, the SMMU 116 may translate addresses for direct memory address (DMA) requests from system input/output (I/O) devices before the requests are passed to interconnect 110. Processing unit 100 may also include a system control processor (SCP) 118. The SCP 118 may be configured to handle various system management functions. In some examples, the SCP 118 may include separate microcontrollers (or processors). In some examples, the SCP 118 may be combined into one or two microcontrollers, or sub-divided into more than two microcontrollers in accordance with various implementations to handle various system management functions.

Interconnect 110 may be configured as a mesh interconnect that forms a high-speed interface that couples each core 102 to the other cores 102 and other components in processing unit 100. Processing unit 100 may also include memory channel controllers 120 that may be operatively coupled to various memory devices (e.g., external to the processing unit 100). For example, the memory channel controllers 120 may be configured for accessing memory, such as a double data rate (DDR) synchronous dynamic random-access memory (SDRAM) or other memory sources.

It is to be appreciated that the processing unit 100 of FIG. 1 may be configured according to a monolithic die design or a disaggregated chiplet design. That is, for example, in the monolithic die design, the cores 102, interconnect 110, memory 114, SMMU 116, and SCP 118 may be configured on a single die. In some cases, for example, in the disaggregated chiplet design, each chiplet of multiple disaggregated chiplets may include a subset of the cores 102 (e.g., in a tiled fashion) with a memory controller to control a portion of memory 114, and a peripheral component interconnect (PCI) or PCI express (PCIe) controller to control the interface with interconnect 110, SMMU 116, and/or SCP 118. Additionally, or alternatively, other computer architecture designs may be used in various implementations given the benefit of the disclosure.

FIG. 2 illustrates an example of a domain-specific prefetcher hardware structure 200 for prefetching virtual addresses, according to aspects of the disclosure. The domain-specific prefetcher hardware structure 200 is configured to observe load and store access patterns and prefetches data based on the past access behavior corresponding to these observed patterns. In some examples, the domain-specific prefetcher hardware structure 200 may be included in a processing core 202. The processing core 202 may include aspects from processing core 102 and/or any other processing core described herein. That is, for example, aspects of the domain-specific prefetcher hardware structure 200 may be implemented as prefetcher logic 108 in processing core 102.

In some scenarios, cloud native workloads running on a processing unit may exhibit irregular, array-indirect accesses. These irregular, array-indirect accesses may cause the cloud native workloads to be memory-latency bound (e.g., graph, hash tables, etc.). In some cases, the instruction per cycle (IPC) of these cloud native workloads can be improved by accurately prefetching these irregular, array-indirect accesses that would otherwise result in long-latency accesses. Various array-indirect access patterns are not well-captured by existing prefetcher architectures.

Accordingly, aspects of the disclosure address the need to incorporate a domain-specific prefetcher architecture capable of (1) identifying array-indirect relationship patterns with an acceptable success rate and (2) accurately and securely prefetching for these irregular, array-indirect accesses. Additionally, or alternatively, because cloud servers often run diverse workloads consisting of both array-indirect accesses and other access types without array-indirect characteristics, the domain-specific prefetcher hardware structure 200 is designed such that an excessive power tax is avoided when processing these other access types. For example, some unnecessary or inaccurate prefetch operations may be performed by a prefetcher when a processing core is running workloads without any array-indirect accesses. As such, unnecessary or inaccurate prefetch operations are minimized by various design aspects of the domain-specific prefetcher hardware structure 200 so that the power tax on the processing core 202 is minimized. Additionally, or alternatively, potential producers for the data-dependent accesses (DDAs) are identified in the domain-specific prefetcher hardware structure 200 using a stride-based prefetcher. As such, the domain-specific prefetcher hardware structure 200 performs training on high-interest program counters (PCs) and the training logic can remain idle until a potential producer is identified thereby avoiding the associated power consuming operations of the training logic.

Array-indirect hardware prefetchers are designed to improve the performance of DDAs across graph analytics (GA) frameworks. Certain array-indirect hardware prefetcher architectures may be inadequate for prefetching array-indirect accesses in cloud servers that handle cloud native workloads. First, the out-of-order training in a typical array-indirect hardware prefetcher architecture may not be sufficiently accurate to provide an acceptable success rate for prefetch training for cloud servers. Second, a typical array-indirect hardware prefetcher architecture is focused on GA workloads and does not consider or address the power tax issue for non-GA workloads.

Because cloud servers generally run heterogeneous workloads that may or may not exhibit array-indirect accesses, aspects of the disclosure relate to ensuring that the power tax for the workloads with other access types that do not exhibit array-indirect accesses is as low as possible. It is to be noted that a typical array-indirect hardware prefetcher architecture's out-of-order training makes it difficult to optimize power. Further, a typical array-indirect hardware prefetcher architecture typically does not consider ensuring the security of the prefetcher, which may be critical for some cloud customers (e.g., certain integrated chip designs with data-dependent prefetchers have been compromised in the past). For example, certain prefetchers may prefetch data that is out of bounds of the address array being predicted as a next processing core request. Thus, a prefetcher may prefetch this data before the prefetcher realizes (e.g., through subsequent failed validations) that the program doesn't intend to access beyond the address array bounds. For example, an indirection-based data memory-dependent prefetcher that prefetches the certain patterns can be coerced to leak all of program memory in some scenarios.

At least for these reasons, the domain-specific prefetch hardware structure 200 described herein differs from a typical array-indirect hardware prefetcher architecture. In some aspects, the domain-specific prefetch hardware structure 200 is an accurate, secure, and power-optimized prefetcher design desirable for processing units configured for cloud servers.

In accordance with some aspects, the training and confidence measurement in the domain-specific prefetch hardware structure 200 occur at the commit stage to ensure a high success rate of finding array-indirect relationships. In contrast, a typical array-indirect hardware prefetcher architecture may train at the cache-access time, which may be vulnerable to out-of-orderness. This out-of-orderness characteristic in a typical array-indirect hardware prefetcher architecture makes it difficult to find correct relationships with high success rate.

Performing the training and confidence measurement at the commit stage enables throttling training and confidence measurement for power while minimizing any impact on performance. Additionally, or alternatively, performing the training and confidence measurement at the commit stage enables gating for security while minimizing any impact on performance upon entering a new context. In this manner, new array-indirect and/or other data-dependent relationships may be determined quickly.

In the example of FIG. 2, a program counter (PC) transition history (PTH) 210 and data retrieval table (DRT) 220 are configured to enable training at commit time. In some examples, the PTH 210 may be an M-entry (e.g., 4-entry, etc.) first-in first-out (FIFO) buffer that records the PCs exhibiting high-confidence stride accesses in a precision, coverage, and pollution (PCP) stride prefetcher 212. That is, for example, the PTH 210 may be configured to store a plurality of PCs identified by the PCP stride prefetcher 212 as having stride accesses at or above a minimum stride confidence threshold. A typical array-indirect hardware prefetcher architecture training considers these PCs potentially likely to establish an array-indirect relationship. The DRT 220 stores the data of certain loads until they have committed, thus making the data available at commit for array-indirect training and confidence measurement.

In some examples, the DRT 220 may be an 8-entry table indexed by load buffer identifier (LOBID) (e.g., LOBID[2:0]). In some cases, a new entry may be allocated to the DRT 220 at a load issue if (1) the PC of the load exists in the PTH 210; (2) if the load's PC is also the PC in the first entry of an address data table (ADT) 230; or (3) if the load's PC is building confidence in the relationship table (RT) 240. That is, example, when the data of an allocated entry of the DRT 220 is available, the data field of the DRT entry is populated. In some examples, when a load corresponding to an allocated entry of the DRT 220 is committed, the entry is freed once the data has been consumed for training.

In addition to the PTH 210, DRT 220, ADT 230, and RT 240, the domain-specific prefetch hardware structure 200 may also include a prefetch queue 250, a prefetch outstanding buffer (POB) 260, and additional hardware structures. As illustrated in FIG. 2, additional hardware blocks, traces, and operations may be included in the domain-specific prefetch hardware structure 200.

In accordance with some aspects, at operation 215, the PTH 210 may allocate LOBIDs and data of loads that belong to the PCs in the PTH 210. That is, for example, when a load executes, information associated with the executed load (e.g., PC, virtual address, valid bits, data, etc.) may be kept in a storage buffer, such as a load ordering buffer (LOB) until the load can be retired. The LOB may have several entries that are indexed by a pointer called the LOBID.

In some examples, the DRT 220 may allocate entries therein using the LOBID. In this manner, when loads are being tracked by the domain-specific prefetch hardware structure 200 to obtain data, the data can be written into the DRT as well (e.g., along with the PC and virtual address of the executed load) for later use. That is, for example, the DRT 220 may be provided the data of a potential producer PC that is available at the commit stage. Operation 215 assists the training phase to obtain data at commit time. Some arrows in the domain-specific prefetch hardware structure 200 correspond to training traces: first training trace 214, second training trace 222, third training trace 224, fourth training trace 226, fifth training trace 234, and sixth training trace 244.

The first training trace 214 is between the PCP stride prefetcher 212 and the PTH 210. In some cases, if a PC has already been identified as having a strided access pattern (e.g., the PC is in the ACT_HI state), a subsequent successful stride match will trigger this PC's write to the PTH 210. That is, for example, the PCP stride prefetcher 212 provides PCs with successful stride matches (e.g., ACT_HI→ACT_HI) to the PTH 210 via the first training trace 214. The PTH 210 may use the PCs received from the PCP stride prefetcher 212 for operation 215 discussed above. The second training trace 222 provides a load commit PC (e.g., PC [<X>] virtual address [<0x0002a>]) to the DRT 220.

The DRT 220 may act on the load commit PC received from the second training trace 222 depending on whether the data entry (e.g., 8 bytes of data) for the load commit PC is included in the DRT 220 or whether the load commit PC is already triggered in the ADT 230. For example, if the data entry for the load commit PC is not included in the DRT 220, then the third training trace 224 may be selected (e.g., ‘no’ branch). If data entry for the load commit PC is included in the DRT 220, then the fourth training trace 226 may be selected (e.g., ‘yes’ branch).

In some examples, when the third training trace 224 is selected (e.g., ‘no’ branch), a decision operation 232 is made whether the ADT 230 is already triggered for the load commit PC such that the PC is a potential consumer to be matched with an entry having the same PC in the ADT 230. If the ADT 230 is already triggered for the load commit PC, then the fifth training trace 234 operates to send the virtual address of the potential consumer PC and the data of the potential consumer PC to the ADT 230 for population in the ADT 230. If the ADT 230 is not already triggered for the PC of the potential consumer, then the decision operation 232 of the domain-specific prefetch hardware structure 200 operates to drop the load commit PC that was received from the second training trace 222.

In some examples, when the fourth training trace 226 is selected (e.g., ‘yes’ branch), the ADT 230 will be triggered with the PC of the potential producer-consumer pair. That is for example, the fourth training trace 226 operates to send the virtual address and the data of the potential producer/consumer PC stored in the DRT 220 to the ADT 230 for population as an entry in the ADT 230.

In some examples, the ADT 230 will perform training on the entries of the ADT 230 that have been populated by the DRT 220 to identify DDAs, such as array-indirect and pointer-based accesses between PCs. The sixth training trace 244 operates to send these identified DDAs to the RT 240. That is, for example, the serialized division in the entries of the ADT 230 may identify PC tuples or producer-consumer pairs, and these PC tuples (e.g., [<C, D>], etc.) are sent to the RT 240.

Some arrows in the domain-specific prefetch hardware structure 200 correspond to confidence tracking traces: first confidence tracking trace 228, second confidence tracking trace 238, and third confidence tracking trace 246. In some examples, the first confidence tracking trace 228 provides a confidence measurement corresponding to the PC of the producer. For example, if the load commit PC provided to the DRT 220 via the second training trace 222 is included as a producer PC in the RT 240 (e.g., if (PC [<X>] ==a producer PC in the RT 240, etc.), then a virtual address may be predicted using the possible PC tuples associated with the load commit PC (e.g., [<C, D>], [<B, C>], etc.).

In some examples, the second confidence tracking trace 238 provides a confidence measurement corresponding to the PC of the consumer. For example, if the load commit PC provided to the DRT 220 via the second training trace 222 is included as a consumer PC in the RT 240 (e.g., PC [<X>]==a consumer PC in the RT 240, etc.) and a predicted virtual address stored in the RT 240 is equals to the virtual address associated with the load commit PC (e.g., stored predicted virtual address==[<0x0002a>], etc.), then a confidence level attributed to the virtual address associated with the load commit PC is increased (e.g., confidence++, etc.); else the confidence level attributed to the virtual address associated with the load commit PC is decreased (e.g., confidence−−, etc.). The third confidence tracking trace 246 operates to provide these confidence measurements to the RT 240.

Some arrows in the domain-specific prefetch hardware structure 200 correspond to prefetch generation traces: first prefetch generation trace 216, second prefetch generation trace 236, third prefetch generation trace 242, fourth prefetch generation trace 248, fifth prefetch generation trace 252, sixth prefetch generation trace 254, and seventh prefetch generation trace 264. The first prefetch generation trace 216 operates to send PCP stride information from the PCP stride prefetcher 212 to the cache line (CL) staging buffer 218. That is, for example, CL staging may be performed by the domain-specific prefetch hardware structure 200 such that when an identified producer PC obtains fill data from a memory location (e.g., L2 cache, etc.). The data from the memory location may be locally staged and sliced up in the data chunks (e.g., 4-or 8-byte data chunks, etc.) to compute prefetch addresses based on the obtained data. The second prefetch generation trace 236 operates to provide a demand fill to the CL staging buffer 218.

In some examples, the CL staging buffer 218 performs a CL stepping function. The third prefetch generation trace 242 operates to provide data from CL stepping of the CL staging buffer 218 to the RT 240. In some implementations, the data from CL stepping of the CL staging buffer 218 is either 4 bytes or 8 bytes. The RT 240 includes DDAs and confidence in the entries of the RT 240 is built based on inputs from the third confidence tracking trace 246. The domain-specific prefetch hardware structure 200 generates prefetch operation when the entries of the RT 240 satisfy a confidence threshold level.

In some examples, the fourth prefetch generation trace 248 operates to send the virtual address associated with the prefetch operation to the prefetch queue 250. The domain-specific prefetch hardware structure 200 performs a virtual-to-physical address translation in the prefetch queue 250 with respect to a translation lookaside buffer. If there is a translation lookaside buffer hit, the fifth prefetch generation trace 252 operates to send the successful prefetch operation and corresponding address information to the load pipeline for launching the prefetch operation.

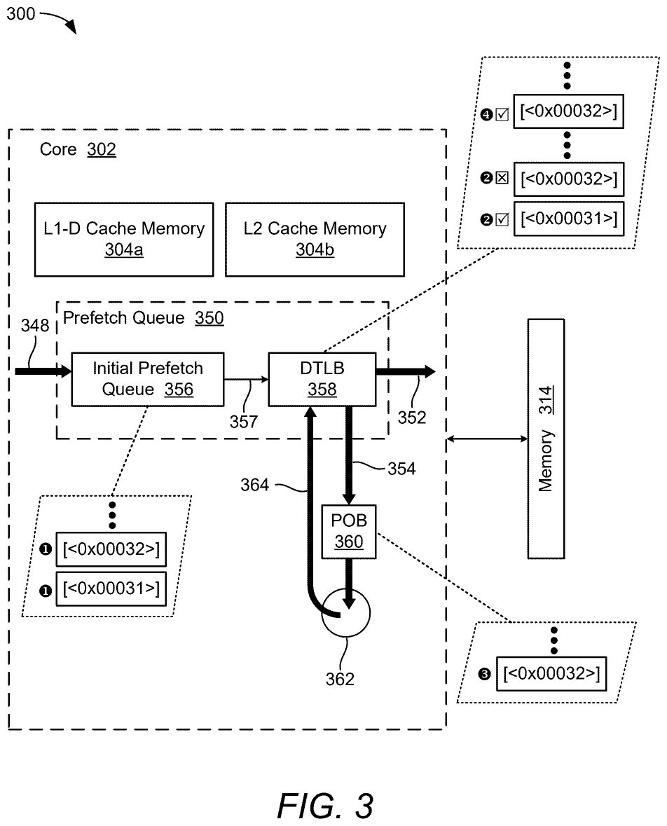

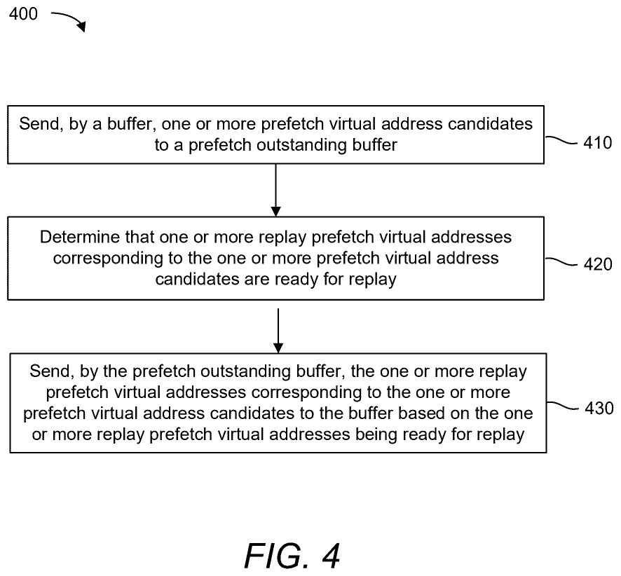

In some examples, if there is a translation lookaside buffer miss, the sixth prefetch generation trace 254 operates to send the missed prefetch operation and corresponding address information to the prefetch outstanding buffer (POB) 260 for performing a replay process 262 to possibly replay the virtual address of the missed prefetch operation. The seventh prefetch generation trace 264 operates to send the virtual address of the missed prefetch operation for replay back to the translation lookaside buffer based on the result of the replay process 262. Hardware structures and techniques for replaying virtual addresses are further described with respect to FIGS. 3 and 4.

Cache prefetch operations using virtual addresses in a data translation lookaside buffer (dTLB) may result in prefetch virtual address misses, also may be referred to as prefetch TLB lookup misses, during address translations (e.g., the process of translating virtual addresses into physical addresses). Typically, a transaction in the virtual address space operates to first lookup to translate the virtual address to physical address. Then another lookup may be performed to retrieve the data. When a prefetch virtual address miss is detected, the virtual address is typically dropped thereby forgoing an opportunity to prefetch the data associated with the virtual address into cache. Accordingly, if the data associated with the dropped prefetch virtual address is indeed needed by the processing core, a loss of performance (e.g., a reduction in the IPC of a workload) may result.

FIG. 3 illustrates an example of a replay hardware structure 300 for replaying prefetch virtual addresses, according to aspects of the disclosure. The replay hardware structure 300 may be included in a processing core 302. The processing core 302 may include aspects from processing core 102, processing core 202, and/or any other processing core described herein. The replay hardware structure 300 and aspects thereof may be incorporated into a prefetcher, such as but not limited to the domain-specific prefetcher hardware structure 200. That is, for example, aspects of the replay hardware structure 300 may be implemented as prefetcher logic 108 in processing core 102.

In accordance with some aspects, the cache prefetch operations associated with a prefetcher using the replay hardware structure 300 are presumed to be timely. That is, for example, on the whole, the cache prefetch operations associated with the prefetcher using the replay hardware structure 300 are deemed appropriate and timely. As such, it may be beneficial to replay a prefetch virtual address down the load pipeline of the processing core 302 despite initially resulting in a prefetch virtual address miss. That is, for example, entries in a translation lookaside buffer (e.g., the dTLB 358) or like structure may store information about a virtual-to-physical page translation. The replay of the prefetch virtual address may be successful when the corresponding virtual-to-physical page translation has been subsequently received and entered into the translation lookaside buffer. In some aspects, the performance of the processing core 302 that replays these prefetch virtual addresses within a prefetcher of the processing core 302 is increased. In some examples, a cache prefetch may remain in a fill queue until the prefetcher receives data from a memory location (e.g., L2 cache, etc.). If, during this waiting period, a demand fill request occurs with an address matching that of the cache prefetch, the prefetcher knows that the cache prefetch was not timely enough to prevent the demand fill from requiring a fill from the memory location (e.g., L2 cache, etc.).

In some examples, the prefetcher may be a domain-specific prefetcher or the like that is configured to support irregular, array-indirect accesses associated with various workloads (e.g., cloud native workloads) and may encounter a substantial number of prefetch virtual address misses with respect to the dTLB 358. In some examples, rather than dropping the virtual addresses associated with the prefetch virtual address misses, the prefetcher may replay at least some of these virtual addresses to obtain the data from memory to be stored in cache thereby achieving higher performance for the processing core 302.

As illustrated in the example of FIG. 3, the replay hardware structure 300 within the processing core 302 includes L1 Data-cache 304a, L2 Cache 304b, a prefetch queue 350, and a prefetch outstanding buffer (POB) 360. In some implementations, the POB 360 has 12 entries. Prefetch virtual addresses associated with prefetch operations may be received via trace 348 and queued into an initial prefetch queue 356. In an example operation, a first prefetch virtual address (e.g., [<0x00031>]) of a first prefetch operation may be issued via prefetch issue trace 357 from the initial prefetch queue 356 (e.g., shown as operational instance (1) for [<0x00031>] in FIG. 3) to the dTLB 358. The first prefetch virtual address may register a hit in the dTLB 358 (e.g., shown as operational instance (2) for [<0x00031>] in FIG. 3). That is, for example, a virtual-to-physical address translation is successfully performed in the dTLB 358.

Information related to the physical address of the first prefetch operation may be sent for prefetch processing via a prefetch hit trace 352. That is, for example, the physical address of the first prefetch operation may correspond to a memory location in the L2 Cache 304b, memory 314, or other memory, and the corresponding prefetch data may be stored in the L1 Data-cache 304a or another cache.

In another example operation, a second prefetch virtual address (e.g., [<0x00032>]) of a second prefetch operation may be issued via the prefetch issue trace 357 from the initial prefetch queue 356 (e.g., shown as operational instance (1) for [<0x00032>] in FIG. 3) to the dTLB 358. The second prefetch virtual address may register a miss in the dTLB 358 (e.g., shown as operational instance (2) for [<0x00032>] in FIG. 3). That is, for example, no virtual-to-physical address translation is found in the dTLB 358 for the second prefetch virtual address. Rather than dropping the second prefetch virtual address, the second prefetch virtual address is sent via prefetch virtual address miss trace 354 to the POB 360 (e.g., shown as operational instance (3) for [<0x00032>] in FIG. 3) to be processed as a prefetch virtual address candidate.

In some examples, the POB 360 may first verify whether the second prefetch virtual address candidate is already included as an entry in the POB 360. If the second prefetch virtual address is already included as an entry in the POB 360, the second prefetch virtual address candidate is not added to the POB 360 to avoid duplicate entries therein. The initial entry corresponding to the second prefetch virtual address candidate will remain in the POB 360 and await a virtual-to-physical address translation. That is, for example, the entries in the POB 360 are unique cache line addresses to optimize the replay hardware structure 300.

In some examples, if the second prefetch virtual address candidate is not already included as an existing entry in or absent from the POB 360, the second prefetch virtual address candidate is entered as an entry in the POB. The replay hardware structure 300 and/or the associated domain-specific prefetcher may perform a replay process 362 associated with the second prefetch virtual address and other prefetch virtual addresses for the prefetch virtual address candidate entries in the POB 360. That is, for example, a virtual-to-physical address translation request corresponding to the second prefetch virtual address candidate may be sent to a memory management unit (MMU) (not shown) or other memory management structures. The MMU may use page tables and table-walking hardware to translate virtual addresses into the physical addresses corresponding to memory (e.g., memory 314 or the various memory devices controlled by memory channel controllers 120).

If the MMU responds that the MMU can accommodate the virtual-to-physical address translation request, the second prefetch virtual address (e.g., [<0x00032>]) candidate is inserted into the POB 360 along with an outstanding translation buffer identifier (OTB ID). When the MMU responds with the virtual-to-physical address translation, the OTB ID in the MMU response is compared with the OTB IDs of the entries in the POB 360. If the OTB ID associated with the second prefetch virtual address candidate matches with the OTB ID in the MMU response, the second prefetch virtual address candidate is marked in the POB 360 as ready for replay.

If, however, a virtual-to-physical address translation request is unsuccessful, the prefetch virtual address candidate is dropped from the POB 360. For example, an unsuccessful physical address translation request may result when the MMU responds that the MMU cannot accommodate the virtual-to-physical address translation request. In some cases, such an unsuccessful physical address translation request may occur due to resource constraints associated with the MMU. Additionally, or alternatively, an unsuccessful physical address translation request may result when no response having the OTB ID associated with the prefetch virtual address candidate is received from the MMU after initially indicating the prefetch virtual address candidate could be accommodated or if the MMU responds that there is a translation page fault.

Once the second prefetch virtual address (e.g., [<0x00032>]) candidate is marked as ready for replay, the second prefetch virtual address is scheduled for reissue and sent from the POB 360 to the dTLB 358 via a prefetch replay trace 364. Based on the successful replay process 362 for the second prefetch virtual address candidate, the second prefetch virtual address registers a hit during the subsequent virtual-to-physical address translation attempt in the dTLB 358 (e.g., shown as operational instance (4) for [<0x00032>] in FIG. 3). The information related to the physical address of the second prefetch operation may then be sent for prefetch processing via the prefetch hit trace 352.

In some examples, when marked as ready for replay, the replay of prefetch virtual addresses via the prefetch replay trace 364 to the dTLB 358 is scheduled before a next virtual address queued in the initial prefetch queue 356 is issued to the dTLB 358. That is, for example, the prefetch virtual addresses that are ready for replay are reissued from the POB 360 down the prefetch load pipeline. During arbitration for the prefetch load pipeline, these ready-to-replay prefetch virtual addresses in the POB 360 get priority over the prefetch virtual addresses in the initial prefetch queue 356.

That is, for example, a scheduler and a load-store unit (not shown) of the processing core 302 may operate in conjunction with the replay hardware structure 300 to prioritize the replay prefetch virtual addresses over initial prefetch virtual addresses in the initial prefetch queue 356. This optimization considers the efficacy of the prefetch operation that initially missed and the temporal nature of replaying the prefetch operation down the prefetch load pipeline such that the replayed prefetch operation does not become stale.

While the replay hardware structure 300 in the example of FIG. 3 is described in the context of a domain-specific prefetcher, the disclosed prefetch virtual address replay techniques are not limited thereto. That is, for example, replay hardware structures including POBs and virtual address replay techniques may be used in various cache and memory management unit contexts of a processing unit having a plurality of processing cores, in accordance with some aspects. For example, aspects of the subject technology may be implemented in a cache or memory management unit hardware structure or system that generates various types of prefetch virtual address candidates.

In some aspects, a POB may be configured to hold prefetch virtual addresses to replay for various reasons in the event that such prefetch virtual addresses are dropped (e.g., not just as the result of prefetch virtual address misses with respect to a dTLB). For example, virtual address candidates may correspond to paused prefetching operations. That is, for example, a prefetcher may be signaled to temporarily pause the prefetching operations due to low bandwidth available or other considerations. The queued virtual addresses may be virtual address candidates for entry into the POB upon the resumption of prefetching operations.

In some examples, virtual address candidates may correspond to a prefetch hit associated with the L1 Data-cache for which the data is expected to be evicted from the L1 Data-cache. That is, for example, the virtual address associated with the prefetch hit may be stored in a POB and prefetched again at a later time during the program execution because the data is expected to be evicted from the L1 Data-cache.

In some examples, the virtual address candidates may correspond to virtual addresses for data associated with line fill buffers. That is, for example, the line fill buffers may serve as cacheline-sized buffers that hold translation requests waiting for data from the L2 cache and in which data is merged before being sent to the L1 Data-cache. That is, for example, a prefetcher may store a virtual address candidate for replay to the POB when the translation buffer in the MMU is full and is currently unable to accept additional translation requests.

In some examples, the virtual address candidates may correspond to virtual addresses passed to the POB based on an eviction of data associated with the prefetch virtual address from a first-in first-out (FIFO) buffer. That is, for example, a prefetcher may have a high confidence level of the prefetch virtual address being needed by the processing core after the data is expected to be evicted.

Additionally, or alternatively, the prefetcher may be an instruction prefetcher unit and the translation lookaside buffer may be an instruction translation lookaside buffer (iTLB), in accordance with some examples.

FIG. 4 is a flowchart of an example process 400 associated with techniques for replaying prefetch virtual addresses, according to aspects of the disclosure. In some implementations, one or more process blocks of FIG. 4 may be performed by an SoC assembly, a processing unit (e.g., processing unit 100), a processing core (e.g., processing core 102, processing core 202, and/or processing core 302), a prefetcher (e.g., domain-specific prefetcher hardware structure 200 with replay hardware structure 300), or any like apparatus.

As shown in FIG. 4, process 400 may include, at block 410, sending, by a buffer, one or more prefetch virtual address candidates to a prefetch outstanding buffer. Means for performing the operation of block 410 may include any of the apparatuses described herein. For example, the apparatus may send, by the buffer, one or more prefetch virtual address candidates to a prefetch outstanding buffer, using the dTLB 358.

As further shown in FIG. 4, process 400 may include, at block 420, determining that the one or more replay prefetch virtual addresses are ready for replay. Means for performing the operation of block 420 may include any of the apparatuses described herein. For example, the apparatus may determine that the one or more replay prefetch virtual addresses are ready for replay, using the POB 360.

As further shown in FIG. 4, process 400 may include, at block 430, sending, by the prefetch outstanding buffer, one or more replay prefetch virtual addresses corresponding to the one or more prefetch virtual address candidates to the buffer based on the one or more replay prefetch virtual addresses being ready for replay. Means for performing the operation of block 430 may include any of the apparatuses described herein. For example, the apparatus may send, by the prefetch outstanding buffer, one or more replay prefetch virtual addresses corresponding to the one or more prefetch virtual address candidates to the buffer based on the one or more replay prefetch virtual addresses being ready for replay, using the POB 360.

Process 400 may include additional implementations, such as any single implementation or any combination of implementations described below and/or in connection with one or more other processes described elsewhere herein.

In some aspects, process 400 includes the buffer is a translation lookaside buffer, and the translation lookaside buffer is configured to send the prefetch outstanding buffer the one or more prefetch virtual address candidates based on one or more virtual-to-physical address translation misses by the translation lookaside buffer.

In some aspects, process 400 includes entering a prefetch virtual address candidate of the one or more prefetch virtual address candidates as an entry in the prefetch outstanding buffer based on the prefetch virtual address candidate being absent in the prefetch outstanding buffer.

In some aspects, process 400 includes refraining from entering a prefetch virtual address candidate of the one or more prefetch virtual address candidates based on the prefetch virtual address candidate being an existing entry in the prefetch outstanding buffer.

In some aspects, process 400 includes sending a virtual-to-physical address translation request corresponding to a prefetch virtual address candidate of the one or more prefetch virtual address candidates to a memory management unit (MMU), wherein the virtual-to-physical address translation request includes an outstanding translation buffer identifier (OTB ID) associated with a prefetch virtual address of the prefetch virtual address candidate.

In some aspects, process 400 includes marking the prefetch virtual address candidate as ready for replay based on a response from the MMU indicating the OTB ID and that a virtual-to-physical address translation of the prefetch virtual address has been completed, or dropping the prefetch virtual address candidate based on the response to the virtual-to-physical address translation request from the MMU indicating that the physical address translation request is unavailable.

In some aspects, process 400 includes dropping the prefetch virtual address candidate based on the response to the virtual-to-physical address translation request from the MMU indicating that the physical address translation request cannot be accommodated or indicating a translation page fault.

In some aspects, process 400 includes receiving, in the buffer, one or more initial prefetch virtual addresses from a prefetch queue different from the prefetch outstanding buffer and prioritizing the one or more replay prefetch virtual addresses from the prefetch outstanding buffer over the one or more initial prefetch virtual addresses from the prefetch queue different from the prefetch outstanding buffer.

In some implementations, a prefetcher may be used to perform the process 400. For example, the prefetcher may include a buffer and a prefetch outstanding buffer operatively coupled to the buffer. In some cases, the buffer is configured to send one or more prefetch virtual address candidates to the prefetch outstanding buffer, and the prefetch outstanding buffer is configured to send one or more replay prefetch virtual addresses corresponding to the one or more prefetch virtual address candidates to the buffer based on the one or more replay prefetch virtual addresses being ready for replay.

In some cases, the buffer is a translation lookaside buffer, and the translation lookaside buffer is configured to send the prefetch outstanding buffer the one or more prefetch virtual address candidates based on one or more virtual-to-physical address translation misses by the translation lookaside buffer. In some cases, the translation lookaside buffer is a data translation lookaside buffer (dTLB).

In some cases, the prefetch outstanding buffer is configured to enter a prefetch virtual address candidate of the one or more prefetch virtual address candidates as an entry in the prefetch outstanding buffer based on the prefetch virtual address candidate being absent in the prefetch outstanding buffer.

In some cases, the prefetch outstanding buffer is configured to refrain from entering a prefetch virtual address candidate of the one or more prefetch virtual address candidates based on the prefetch virtual address candidate being an existing entry in the prefetch outstanding buffer.

In some cases, the prefetch outstanding buffer is configured to send a virtual-to-physical address translation request corresponding to a prefetch virtual address candidate of the one or more prefetch virtual address candidates to a memory management unit (MMU). In some cases, the virtual-to-physical address translation request includes an outstanding translation buffer identifier (OTB ID) associated with a prefetch virtual address of the prefetch virtual address candidate.

In some cases, the prefetch outstanding buffer is configured to mark the prefetch virtual address candidate as ready for replay based on a response from the MMU indicating the OTB ID and that a virtual-to-physical address translation of the prefetch virtual address has been completed. In some cases, the prefetch outstanding buffer is configured to drop the prefetch virtual address candidate based on the response to the virtual-to-physical address translation request from the MMU indicating that the physical address translation request is unavailable.

In some cases, the prefetch outstanding buffer may drop the prefetch virtual address candidate based on the response to the virtual-to-physical address translation request from the MMU indicating that the physical address translation request cannot be accommodated. In some cases, the prefetch outstanding buffer may drop the prefetch virtual address candidate based on the response to the virtual-to-physical address translation request from the MMU indicating a translation page fault.

In some cases, the buffer is configured to receive one or more initial prefetch virtual addresses from a prefetch queue different from the prefetch outstanding buffer. In some cases, the prefetcher may include logic such that a scheduler (e.g., of a processing core that is configured with the prefetcher) prioritizes the one or more replay prefetch virtual addresses from the prefetch outstanding buffer over the one or more initial prefetch virtual addresses from the prefetch queue different from the prefetch outstanding buffer.

In some cases, the buffer may correspond to one or more line fill buffers. In some cases, the prefetch outstanding buffer may be configured to receive the one or more prefetch virtual address candidates based on one or more virtual addresses for data associated with the one or more line fill buffers based on a translation buffer in a memory management unit (MMU) being unavailable.

In some cases, the buffer may correspond to one or more first-in first-out (FIFO) buffers. In some cases, the prefetch outstanding buffer may be configured to receive the one or more prefetch virtual address candidates based on eviction of data associated with one or more virtual address of the one or more prefetch virtual address candidates from the one or more FIFO buffer.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Advantages of process 400 include, in some examples, rather than dropping the virtual addresses associated with the prefetch virtual address misses, a prefetcher may replay at least some of these virtual addresses the to obtain the data from memory to be stored in cache thereby achieving higher performance for a processing core.

In one or more example aspects, the functions described may be implemented in hardware, software, firmware, or any combination thereof.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended. Furthermore, it is also intended that aspects of a clause can be included in any other independent clause, even if the clause is not directly dependent on the independent clause.

Implementation examples are described in the following numbered clauses:

Clause 1. A prefetcher, comprising: a buffer; and a prefetch outstanding buffer operatively coupled to the buffer, wherein: the buffer is configured to send one or more prefetch virtual address candidates to the prefetch outstanding buffer, and the prefetch outstanding buffer is configured to send one or more replay prefetch virtual addresses corresponding to the one or more prefetch virtual address candidates to the buffer based on the one or more replay prefetch virtual addresses being ready for replay.

Clause 2. The prefetcher of clause 1, wherein: the buffer is a translation lookaside buffer, and the translation lookaside buffer is configured to send the prefetch outstanding buffer the one or more prefetch virtual address candidates based on one or more virtual-to-physical address translation misses by the translation lookaside buffer.

Clause 3. The prefetcher of clause 2, wherein the translation lookaside buffer is a data translation lookaside buffer (dTLB).

Clause 4. The prefetcher of any of clauses 1 to 3, wherein the prefetch outstanding buffer is configured to enter a prefetch virtual address candidate of the one or more prefetch virtual address candidates as an entry in the prefetch outstanding buffer based on the prefetch virtual address candidate being absent in the prefetch outstanding buffer.

Clause 5. The prefetcher of any of clauses 1 to 4, wherein the prefetch outstanding buffer is configured to refrain from entering a prefetch virtual address candidate of the one or more prefetch virtual address candidates based on the prefetch virtual address candidate being an existing entry in the prefetch outstanding buffer.

Clause 6. The prefetcher of any of clauses 1 to 5, wherein: the prefetch outstanding buffer is configured to send a virtual-to-physical address translation request corresponding to a prefetch virtual address candidate of the one or more prefetch virtual address candidates to a memory management unit (MMU); and the virtual-to-physical address translation request includes an outstanding translation buffer identifier (OTB ID) associated with a prefetch virtual address of the prefetch virtual address candidate.

Clause 7. The prefetcher of clause 6, wherein the prefetch outstanding buffer is configured to: mark the prefetch virtual address candidate as ready for replay based on a response from the MMU indicating the OTB ID and that a virtual-to-physical address translation of the prefetch virtual address has been completed, or drop the prefetch virtual address candidate based on the response to the virtual-to-physical address translation request from the MMU indicating that the physical address translation request is unavailable.

Clause 8. The prefetcher of clause 7, wherein the prefetch outstanding buffer configured to drop the prefetch virtual address candidate based on the response to the virtual-to-physical address translation request from the MMU indicating that the physical address translation request cannot be accommodated or indicating a translation page fault.

Clause 9. The prefetcher of any of clauses 1 to 8, wherein: the buffer is configured to receive one or more initial prefetch virtual addresses from a prefetch queue different from the prefetch outstanding buffer, and the prefetcher further comprises logic such that a scheduler prioritizes the one or more replay prefetch virtual addresses from the prefetch outstanding buffer over the one or more initial prefetch virtual addresses from the prefetch queue different from the prefetch outstanding buffer.

Clause 10. The prefetcher of any of clauses 1 to 9, wherein: the buffer corresponds to one or more line fill buffers, and the prefetch outstanding buffer is configured to receive the one or more prefetch virtual address candidates based on one or more virtual addresses for data associated with the one or more line fill buffers based on a translation buffer in a memory management unit (MMU) being unavailable.

Clause 11. The prefetcher of any of clauses 1 to 10, wherein: the buffer corresponds to one or more first-in first-out (FIFO) buffers, and the prefetch outstanding buffer is configured to receive the one or more prefetch virtual address candidates based on eviction of data associated with one or more virtual address of the one or more prefetch virtual address candidates from the one or more FIFO buffer.

Clause 12. A processing unit, comprising: one or more processing cores, at least one processing core of the one or more processing cores configured to: send one or more prefetch virtual address candidates to a prefetch outstanding buffer; determine that one or more replay prefetch virtual addresses corresponding to the one or more prefetch virtual address candidates are ready for replay; and the send one or more replay prefetch virtual addresses corresponding to the one or more prefetch virtual address candidates to the buffer based on the one or more replay prefetch virtual addresses being ready for replay.

Clause 13. The processing unit of clause 12, wherein: the buffer is a translation lookaside buffer, and the translation lookaside buffer is configured to send the prefetch outstanding buffer the one or more prefetch virtual address candidates based on one or more virtual-to-physical address translation misses by the translation lookaside buffer.

Clause 14. The processing unit of any of clauses 12 to 13, wherein the at least one processing core is further configured to: enter a prefetch virtual address candidate of the one or more prefetch virtual address candidates as an entry in the prefetch outstanding buffer based on the prefetch virtual address candidate being absent in the prefetch outstanding buffer.

Clause 15. The processing unit of any of clauses 12 to 14, wherein the at least one processing core is further configured to: refrain from entering a prefetch virtual address candidate of the one or more prefetch virtual address candidates based on the prefetch virtual address candidate being an existing entry in the prefetch outstanding buffer.

Clause 16. The processing unit of any of clauses 12 to 15, wherein the at least one processing core is further configured to: send a virtual-to-physical address translation request corresponding to a prefetch virtual address candidate of the one or more prefetch virtual address candidates to a memory management unit (MMU), wherein the virtual-to-physical address translation request includes an outstanding translation buffer identifier (OTB ID) associated with a prefetch virtual address of the prefetch virtual address candidate.

Clause 17. The processing unit of clause 16, wherein the at least one processing core is further configured to: mark the prefetch virtual address candidate as ready for replay based on a response from the MMU indicating the OTB ID and that a virtual-to-physical address translation of the prefetch virtual address has been completed; or drop the prefetch virtual address candidate based on the response to the virtual-to-physical address translation request from the MMU indicating that the physical address translation request is unavailable.

Clause 18. The processing unit of clause 17, wherein the at least one processing core is further configured to: drop the prefetch virtual address candidate based on the response to the virtual-to-physical address translation request from the MMU indicating that the physical address translation request cannot be accommodated or indicating a translation page fault.

Clause 19. The processing unit of any of clauses 12 to 18, wherein the at least one processing core is further configured to: receive, in the buffer, one or more initial prefetch virtual addresses from a prefetch queue different from the prefetch outstanding buffer; and prioritize the one or more replay prefetch virtual addresses from the prefetch outstanding buffer over the one or more initial prefetch virtual addresses from the prefetch queue different from the prefetch outstanding buffer.

Clause 20. A method of replaying virtual addresses, comprising: sending, by a buffer, one or more prefetch virtual address candidates to a prefetch outstanding buffer; determining that one or more replay prefetch virtual addresses corresponding to the one or more prefetch virtual address candidates are ready for replay; and sending, by the prefetch outstanding buffer, the one or more replay prefetch virtual addresses corresponding to the one or more prefetch virtual address candidates to the buffer based on the one or more replay prefetch virtual addresses being ready for replay.

Clause 21. The method of clause 20, wherein: the buffer is a translation lookaside buffer, and the translation lookaside buffer is configured to send the prefetch outstanding buffer the one or more prefetch virtual address candidates based on one or more virtual-to-physical address translation misses by the translation lookaside buffer.

Clause 22. The method of any of clauses 20 to 21, further comprising: entering a prefetch virtual address candidate of the one or more prefetch virtual address candidates as an entry in the prefetch outstanding buffer based on the prefetch virtual address candidate being absent in the prefetch outstanding buffer.

Clause 23. The method of any of clauses 20 to 22, further comprising: refraining from entering a prefetch virtual address candidate of the one or more prefetch virtual address candidates based on the prefetch virtual address candidate being an existing entry in the prefetch outstanding buffer.

Clause 24. The method of any of clauses 20 to 23, further comprising: sending a virtual-to-physical address translation request corresponding to a prefetch virtual address candidate of the one or more prefetch virtual address candidates to a memory management unit (MMU), wherein the virtual-to-physical address translation request includes an outstanding translation buffer identifier (OTB ID) associated with a prefetch virtual address of the prefetch virtual address candidate.

Clause 25. The method of clause 24, further comprising: marking the prefetch virtual address candidate as ready for replay based on a response from the MMU indicating the OTB ID and that a virtual-to-physical address translation of the prefetch virtual address has been completed; or dropping the prefetch virtual address candidate based on the response to the virtual-to-physical address translation request from the MMU indicating that the physical address translation request is unavailable.

Clause 26. The method of clause 25, further comprising: dropping the prefetch virtual address candidate based on the response to the virtual-to-physical address translation request from the MMU indicating that the physical address translation request cannot be accommodated or indicating a translation page fault.

Clause 27. The method of any of clauses 20 to 26, further comprising: receiving, in the buffer, one or more initial prefetch virtual addresses from a prefetch queue different from the prefetch outstanding buffer; and prioritizing the one or more replay prefetch virtual addresses from the prefetch outstanding buffer over the one or more initial prefetch virtual addresses from the prefetch queue different from the prefetch outstanding buffer.

Clause 28. A processing core, comprising: means for sending one or more prefetch virtual address candidates to a prefetch outstanding buffer; means for determining that one or more replay prefetch virtual addresses corresponding to the one or more prefetch virtual address candidates are ready for replay; and means for sending the one or more replay prefetch virtual addresses corresponding to the one or more prefetch virtual address candidates to a buffer based on the one or more replay prefetch virtual addresses being ready for replay.

Clause 29. The processing core of clause 28, wherein: the buffer is a translation lookaside buffer, and the translation lookaside buffer is configured to send the prefetch outstanding buffer the one or more prefetch virtual address candidates based on one or more virtual-to-physical address translation misses by the translation lookaside buffer.

Clause 30. The processing core of any of clauses 28 to 29, further comprising: means for entering a prefetch virtual address candidate of the one or more prefetch virtual address candidates as an entry in the prefetch outstanding buffer based on the prefetch virtual address candidate being absent in the prefetch outstanding buffer.

Clause 31. The processing core of any of clauses 28 to 30, further comprising: means for refraining from entering a prefetch virtual address candidate of the one or more prefetch virtual address candidates based on the prefetch virtual address candidate being an existing entry in the prefetch outstanding buffer.

Clause 32. The processing core of any of clauses 28 to 31, further comprising: means for sending a virtual-to-physical address translation request corresponding to a prefetch virtual address candidate of the one or more prefetch virtual address candidates to a memory management unit (MMU), wherein the virtual-to-physical address translation request includes an outstanding translation buffer identifier (OTB ID) associated with a prefetch virtual address of the prefetch virtual address candidate.

Clause 33. The processing core of clause 32, further comprising: means for marking the prefetch virtual address candidate as ready for replay based on a response from the MMU indicating the OTB ID and that a virtual-to-physical address translation of the prefetch virtual address has been completed; or means for dropping the prefetch virtual address candidate based on the response to the virtual-to-physical address translation request from the MMU indicating that the physical address translation request is unavailable.

Clause 34. The processing core of clause 33, further comprising: means for dropping the prefetch virtual address candidate based on the response to the virtual-to-physical address translation request from the MMU indicating that the physical address translation request cannot be accommodated or indicating a translation page fault.

Clause 35. The processing core of any of clauses 28 to 34, further comprising: means for receiving, in the buffer, one or more initial prefetch virtual addresses from a prefetch queue different from the prefetch outstanding buffer; and means for prioritizing the one or more replay prefetch virtual addresses from the prefetch outstanding buffer over the one or more initial prefetch virtual addresses from the prefetch queue different from the prefetch outstanding buffer.

Those of skill in the art will appreciate that information and signals may be represented using any of a variety of different technologies and techniques. Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects described herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium, including but not limited to, computer readable medium or non-transitory storage media known in the art. An example storage medium may be coupled to the processor such that the processor can read information from, and write information to, the storage medium. In the alternative, the storage medium may be integral to the processor. The processor and the storage medium may reside in an ASIC.

Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A prefetcher, comprising:
a buffer; and
a prefetch outstanding buffer operatively coupled to the buffer, wherein:
the buffer is configured to send one or more prefetch virtual address candidates to the prefetch outstanding buffer, and
the prefetch outstanding buffer is configured to send one or more replay prefetch virtual addresses corresponding to the one or more prefetch virtual address candidates to the buffer based on the one or more replay prefetch virtual addresses being ready for replay.

2. The prefetcher of claim 1, wherein:
the buffer is a translation lookaside buffer, and
the translation lookaside buffer is configured to send the prefetch outstanding buffer the one or more prefetch virtual address candidates based on one or more virtual-to-physical address translation misses by the translation lookaside buffer.

3. The prefetcher of claim 2, wherein the translation lookaside buffer is a data translation lookaside buffer (dTLB).

4. The prefetcher of claim 1, wherein the prefetch outstanding buffer is configured to enter a prefetch virtual address candidate of the one or more prefetch virtual address candidates as an entry in the prefetch outstanding buffer based on the prefetch virtual address candidate being absent in the prefetch outstanding buffer.

5. The prefetcher of claim 1, wherein the prefetch outstanding buffer is configured to refrain from entering a prefetch virtual address candidate of the one or more prefetch virtual address candidates based on the prefetch virtual address candidate being an existing entry in the prefetch outstanding buffer.

6. The prefetcher of claim 1, wherein:
the prefetch outstanding buffer is configured to send a virtual-to-physical address translation request corresponding to a prefetch virtual address candidate of the one or more prefetch virtual address candidates to a memory management unit (MMU); and
the virtual-to-physical address translation request includes an outstanding translation buffer identifier (OTB ID) associated with a prefetch virtual address of the prefetch virtual address candidate.

7. The prefetcher of claim 6, wherein the prefetch outstanding buffer is configured to:
mark the prefetch virtual address candidate as ready for replay based on a response from the MMU indicating the OTB ID and that a virtual-to-physical address translation of the prefetch virtual address has been completed, or
drop the prefetch virtual address candidate based on the response to the virtual-to-physical address translation request from the MMU indicating that the physical address translation request is unavailable.

8. The prefetcher of claim 7, wherein the prefetch outstanding buffer configured to drop the prefetch virtual address candidate based on the response to the virtual-to-physical address translation request from the MMU indicating that the physical address translation request cannot be accommodated or indicating a translation page fault.

9. The prefetcher of claim 1, wherein:
the buffer is configured to receive one or more initial prefetch virtual addresses from a prefetch queue different from the prefetch outstanding buffer, and
the prefetcher further comprises logic such that a scheduler prioritizes the one or more replay prefetch virtual addresses from the prefetch outstanding buffer over the one or more initial prefetch virtual addresses from the prefetch queue different from the prefetch outstanding buffer.

10. The prefetcher of claim 1, wherein:
the buffer corresponds to one or more line fill buffers, and
the prefetch outstanding buffer is configured to receive the one or more prefetch virtual address candidates based on one or more virtual addresses for data associated with the one or more line fill buffers based on a translation buffer in a memory management unit (MMU) being unavailable.

11. The prefetcher of claim 1, wherein:
the buffer corresponds to one or more first-in first-out (FIFO) buffers, and
the prefetch outstanding buffer is configured to receive the one or more prefetch virtual address candidates based on eviction of data associated with one or more virtual address of the one or more prefetch virtual address candidates from the one or more FIFO buffer.

12. A processing unit, comprising:
one or more processing cores, at least one processing core of the one or more processing cores configured to:
send one or more prefetch virtual address candidates to a prefetch outstanding buffer;
determine that one or more replay prefetch virtual addresses corresponding to the one or more prefetch virtual address candidates are ready for replay; and
send the one or more replay prefetch virtual addresses corresponding to the one or more prefetch virtual address candidates to a buffer based on the one or more replay prefetch virtual addresses being ready for replay.

13. The processing unit of claim 12, wherein:
the buffer is a translation lookaside buffer, and
the translation lookaside buffer is configured to send the prefetch outstanding buffer the one or more prefetch virtual address candidates based on one or more virtual-to-physical address translation misses by the translation lookaside buffer.

14. The processing unit of claim 12, wherein the at least one processing core is further configured to:
enter a prefetch virtual address candidate of the one or more prefetch virtual address candidates as an entry in the prefetch outstanding buffer based on the prefetch virtual address candidate being absent in the prefetch outstanding buffer.

15. The processing unit of claim 12, wherein the at least one processing core is further configured to:
refrain from entering a prefetch virtual address candidate of the one or more prefetch virtual address candidates based on the prefetch virtual address candidate being an existing entry in the prefetch outstanding buffer.

16. The processing unit of claim 12, wherein the at least one processing core is further configured to:
send a virtual-to-physical address translation request corresponding to a prefetch virtual address candidate of the one or more prefetch virtual address candidates to a memory management unit (MMU), wherein the virtual-to-physical address translation request includes an outstanding translation buffer identifier (OTB ID) associated with a prefetch virtual address of the prefetch virtual address candidate.

17. The processing unit of claim 16, wherein the at least one processing core is further configured to:
mark the prefetch virtual address candidate as ready for replay based on a response from the MMU indicating the OTB ID and that a virtual-to-physical address translation of the prefetch virtual address has been completed; or
drop the prefetch virtual address candidate based on the response to the virtual-to-physical address translation request from the MMU indicating that the physical address translation request is unavailable.

18. The processing unit of claim 17, wherein the at least one processing core is further configured to:
drop the prefetch virtual address candidate based on the response to the virtual-to-physical address translation request from the MMU indicating that the physical address translation request cannot be accommodated or indicating a translation page fault.

19. The processing unit of claim 12, wherein the at least one processing core is further configured to:
receive, in the buffer, one or more initial prefetch virtual addresses from a prefetch queue different from the prefetch outstanding buffer; and
prioritize the one or more replay prefetch virtual addresses from the prefetch outstanding buffer over the one or more initial prefetch virtual addresses from the prefetch queue different from the prefetch outstanding buffer.

20. A method of replaying virtual addresses, comprising:
sending, by a buffer, one or more prefetch virtual address candidates to a prefetch outstanding buffer;
determining that one or more replay prefetch virtual addresses corresponding to the one or more prefetch virtual address candidates are ready for replay; and
sending, by the prefetch outstanding buffer, the one or more replay prefetch virtual addresses corresponding to the one or more prefetch virtual address candidates to the buffer based on the one or more replay prefetch virtual addresses being ready for replay.
